(19) United States
(12) Patent Application Publication
(10) Pub. No.: US 2013/0204712 A1
(43) Pub. Date: Aug. 8, 2013

(54) Systems and Methods for Monetizing Advertisement Locations of Virtual Tour Applications

(71) Applicant: TourWrist, Inc., San Francisco, CA (US)

(72) Inventor: Charles Robert Armstrong, San Francisco, CA (US)

(73) Assignee: TOURWRIST, INC., San Francisco, CA (US)

(21) Appl. No.: 13/748,467

(22) Filed: Jan. 23, 2013

Related U.S. Application Data
(60) Provisional application No. 61/590,677, filed on Jan. 25, 2012.

(51) Int. Cl. G06Q 30/02

(52) U.S. Cl. CPC G06Q 30/0273
USPC 705/14.69

(57) ABSTRACT

The present invention relates to systems and methods for monetizing advertisement locations of virtual tours. A virtual tour author generates a virtual tour for mobile devices, and reserves a suitable modifiable ad location in the virtual tour. One or more annotated links can be assigned to this ad location. The ad location can now be monetized by renting the ad location and/or the one or more annotated links assigned to this ad location. Examples of monetization strategies include auctions and direct/indirect sale channels.

### CROSS REFERENCE TO RELATED APPLICATION

This non-provisional application claims the benefit of provisional application No. 61/590,677 filed on Jan. 25, 2012, entitled “Systems and Methods for Monetizing Advertisement Locations of Virtual Tour Applications”, which application is incorporated herein in its entirety by this reference.

### BACKGROUND

The present invention relates to systems and methods for monetizing ad locations of virtual tours. More particularly, the present invention relates to renting ad locations for placing annotated links to advertisements.

Conventional virtual tours can be pre-annotated during the design phase to include static links to hotspots. These hotspots may be designated to display various forms of advertising media when they are subsequently clicked or tapped by an end user. Where appropriate, revenue may be realized by the virtual tour author or editor as a result of these pre-determined static advertisements they support.

However, these static links to hotspots are inflexible and require re-design of the virtual tours whenever relatively minor changes are required. There is also a lack of competitive marketplace for extracting the optimal monetary value of these potentially lucrative advertisement locations within the virtual tours.

It is therefore apparent that an urgent need exists for a real-time interactive marketplace which empowers virtual tour authors and advertisers to engage one another during the design, construction and/or deployment phase(s) of the virtual tours.

### SUMMARY

To achieve the foregoing and in accordance with the present invention, systems and methods for monetizing ad locations of virtual tours is provided. In particular, the systems and methods for renting ad locations of virtual tours for placement of annotated links to advertisements.

In one embodiment, a virtual tour author generates a virtual tour for mobile devices, and reserves a suitable modifiable ad location in the virtual tour. One or more annotated links can be assigned to this ad location.

The ad location can now be monetized by renting the ad location and/or the one or more annotated links assigned to this ad location. Examples of monetization strategies include auctions and direct/indirect sale channels.

In some embodiments, the ad location can be modified by either the author, the host or the advertiser. It may be possible to place ad locations at dead spaces of the virtual tours, e.g. along the peripheral areas or at nadirs.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 illustrates an exemplary virtual tour using a mobile device with an advertisement location suitable for an annotated link in accordance with one embodiment of the present invention;

FIG. 2 illustrates an integrated advertisement for the embodiment of FIG. 1;

FIG. 3 is a flow diagram illustrating an exemplary auction model for monetizing the ad locations;

FIG. 4 is an exemplary flow diagram illustrating an advertiser initiating a bid for the ad locations suitable for an annotated link;

FIG. 5 is an exemplary flow diagram illustrating the presentation of ads in dead spaces of virtual tours;

FIG. 6 illustrates peripheral dead spaces suitable for the presentation of ads; and

FIG. 7 illustrates a nadir dead space suitable for ad presentation.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

The present invention relates to systems and methods for renting modifiable advertisement (“ad”) locations of virtual tours (“VT”) for placement of annotated links to advertisements. Note that the term “mobile device” is intended to include all portable electronic devices including cellular phones, computerized tablets, cameras, and hand-held gaming devices. Note also that the term “rent” is intended to include many temporal and/or permanent monetization models including lease, purchase and/or license.

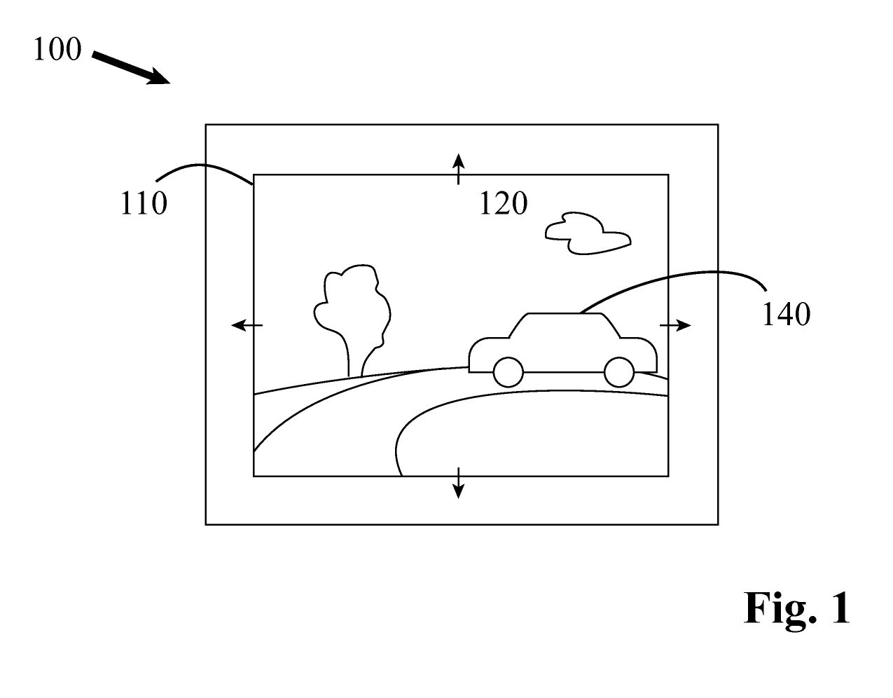

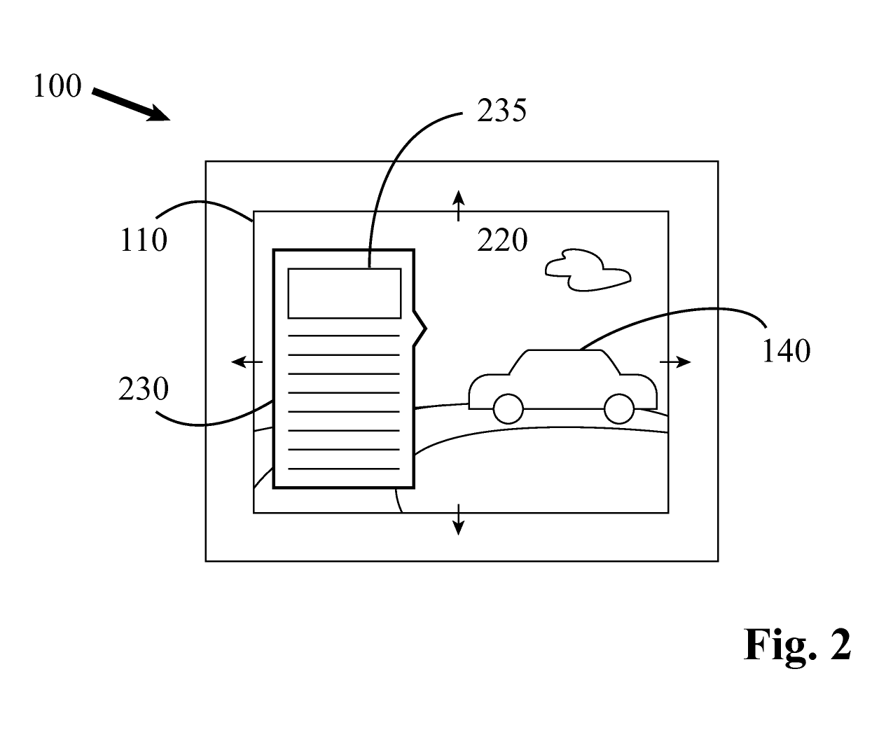

To facilitate discussion, FIG. 1 illustrates an exemplary display 110 of a mobile device 100 which includes an available-for-rent modifiable advertisement location 140 appropriate for the placement of an annotated link to a potential automobile advertisement in accordance with one embodiment of the present invention. FIG. 2 shows an exemplary integrated advertisement 230 provided by an advertiser who has rented the advertisement location 140. Modifiable ad locations, e.g., ad location 140, are intended to be configurable by the VT author, host and/or advertiser. Modifications of ad locations may range from adding/removing/replacing annotated link(s) to changing images in the respective virtual tours.

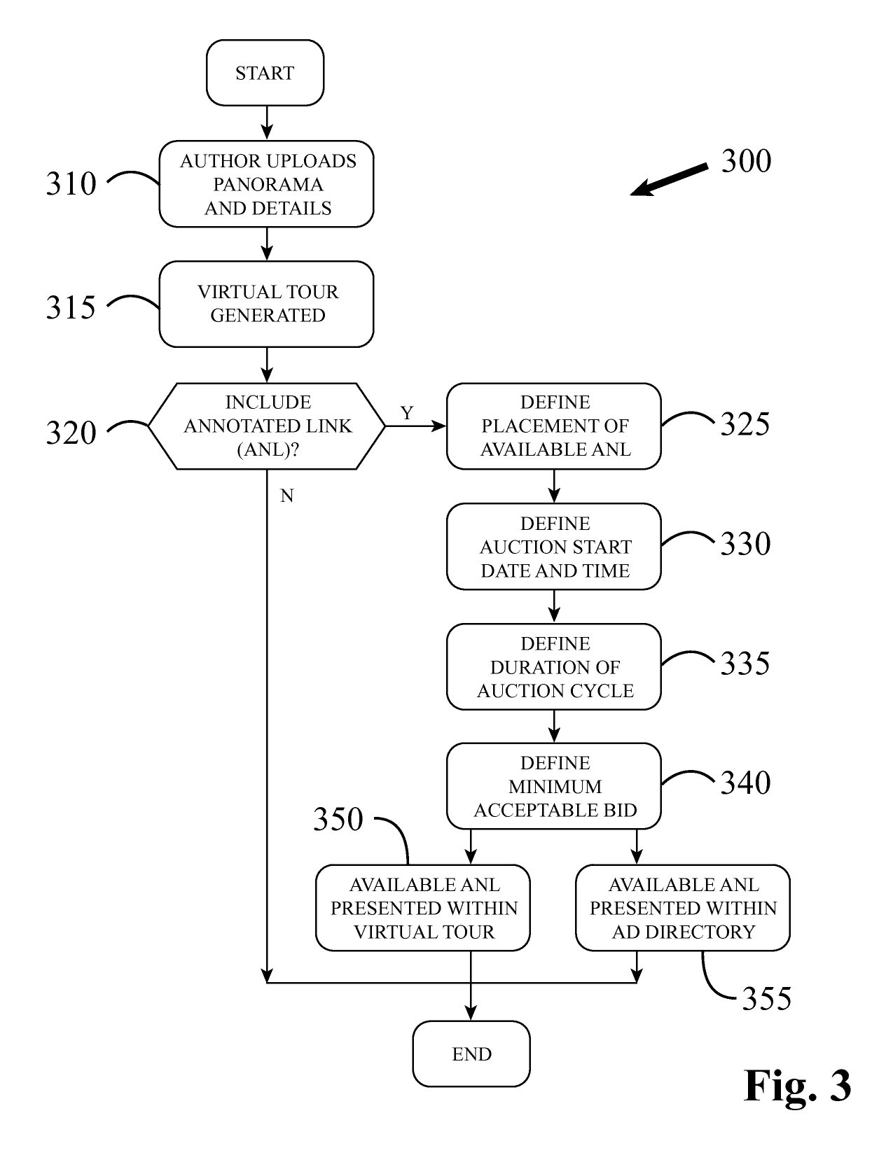

As illustrated by the exemplary flow diagram of FIG. 3, in one embodiment, an author of a virtual tour (steps 310, 315), configured for a mobile device 100, can elect to include one or more annotated links at suitable ad location(s) of the virtual tour (325). The VT host and/or the VT author can now monetize the impressions from these annotated links by using one or more of a variety of methods including auctions and direct/indirect sales, while potentially sharing in the revenue with whichever service provider, e.g., VT host, has facilitated the auction/sale and delivery. Note that in some embodiments, depending on the contractual arrangements, subsequent to the initial release of the virtual tours, the VT host may present or remove ad(s) without knowledge and/or consent of the VT author, and vice versa.

An auction of the annotated link may include defining an auction start date and time (step 330), defining the auction cycle (step 335), and defining an optional minimum bid price or reserve price (step 340). If a service fee or percentage is expected by the service provider for facilitating an auction or the subsequent annotated link delivery, such a fee or percentage may be disclosed at the point of auction creation.

Once an auction has been created, it may be added to an available advertising directory, where third-party advertisers may review it among currently open auctions (355) and bid on those annotated links which they'd like to receive impressions through. Advertisers may also directly encounter and bid on any annotated link within a virtual tour, if it is currently available through an open auction (350).

Upon a successful bid, the winner can present a web page URL or media, to be presented each time the annotated link is subsequently triggered.

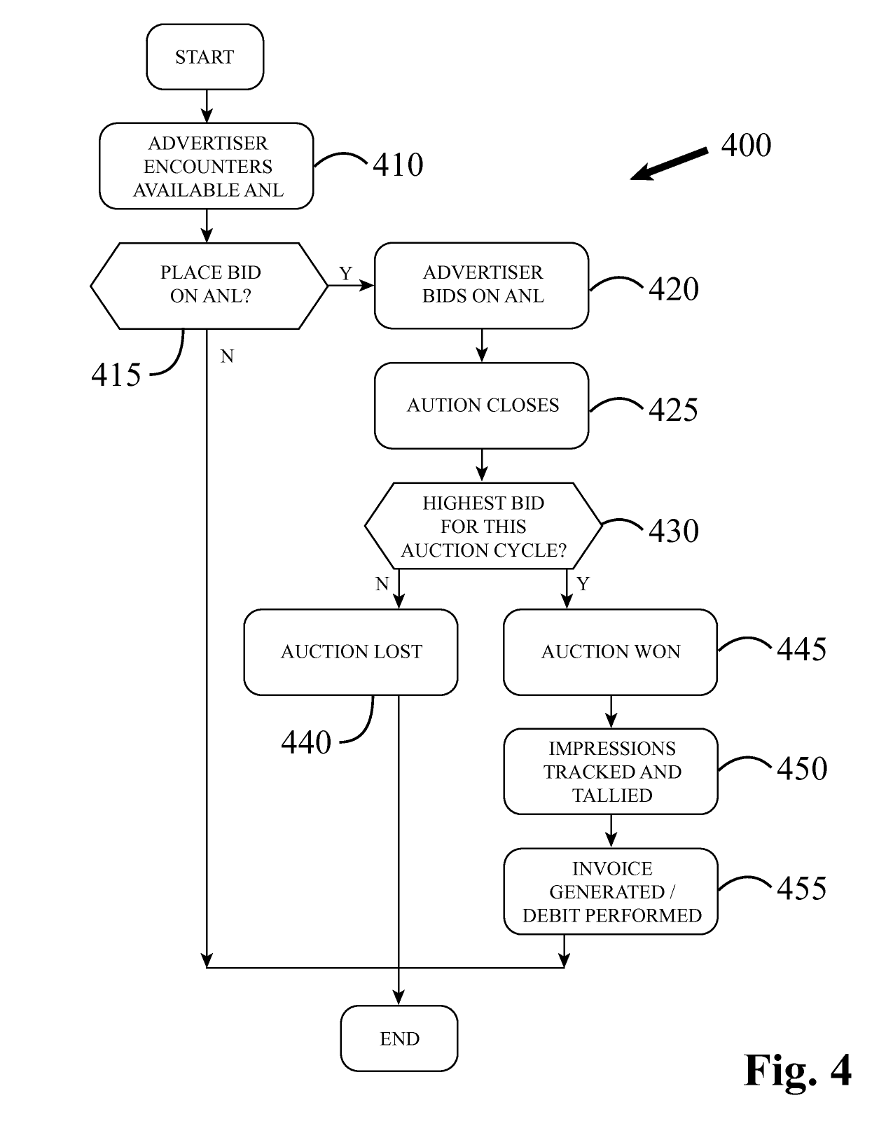

Conversely, as exemplified by the flow diagram of FIG. 4, an advertiser can initiate the monetization process. For example, if an advertiser encounters a desirable ad location with an available, i.e., unassigned, annotated link that is not the subject of an auction (step 410), the advertiser may send the author and/or host an offer to pay for placement of an annotated link within the author's virtual tour (step 415). Should the author and advertiser subsequently come to an agreement on terms, the advertiser may be invoiced and debited (step 455).

In some embodiments, a potential advertiser can initiate the monetization process when the potential advertiser visits a virtual tour and encounters a potentially desirable ad location that has yet to be assigned to any annotated link. In this instance, the advertiser may send the VT author and/or the VT host an offer to pay for initiating and placement of a new annotated link within the author's virtual tour. Should the author and advertiser subsequently come to an agreement on terms, the newly initiated annotated link can be monetized.

It is contemplated that the display of the advertisement (“Ad”) locations on mobile device 100 can be static/dynamic, elective and/or reactive/interactive. For example, a paid tour model may have minimal advertisement locations in combination with ads-on-demand. Conversely, with an unpaid tour model, there could be many more ads, including pop-up ads.

It is also contemplated that ads are intended to include a wide range of speeches, including advertisements for commercial products and/or services, product recalls, political ads, and public service announcements such as Amber alerts, public health warnings and disaster relief announcements.

Ads may also be direct ads or indirect ads. An ad showing the full contact information of a local used car dealer is an example of a direct ad. An example of an indirect ad is an annotated link, e.g., a hotspot with a link to an online ad.

Ads may also be optimally presented in accordance with user profiles within the same virtual tours, i.e., dynamic presentation of contextually relevant ads. For example, a parent of a private middle school student may be presented with an ad for tax-deferred college saving program(s), while the student may be presented with fast food option(s) in the college neighborhood.

Ads may also be presented in accordance with the route taken by the virtual visitor. For example, upon arrival at the gift shop of a virtual tour of a college campus, a potential college student who just toured the weight training facility may be presented with different ad choice(s) than a different potential college student who just toured the music department.

Many modifications and additions are also possible. For example, multiple ranked ads may also be presented to a VT visitor. Ranking may be arranged based on monetization models and/or contextual relevance such as user profiles or geographical factors.

It should be appreciated that many variations of payment models are also possible, including flat base fee with pay-per-link-activation, pay-per-activation only, and flat fee only. Fees can also vary according to one or more variables such as time-of-day, virtual traffic density, an advertiser's predefined threshold for outbidding other bids that may be submitted, the collective number of impressions generated, and more.

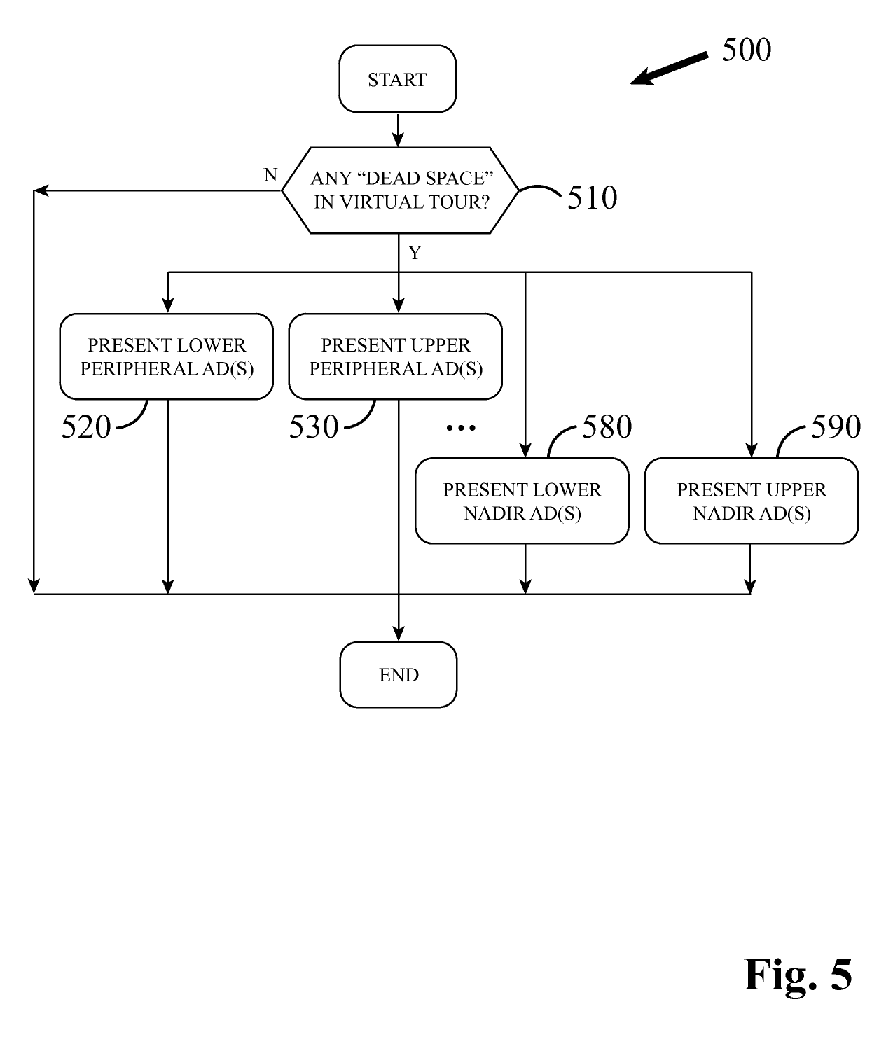

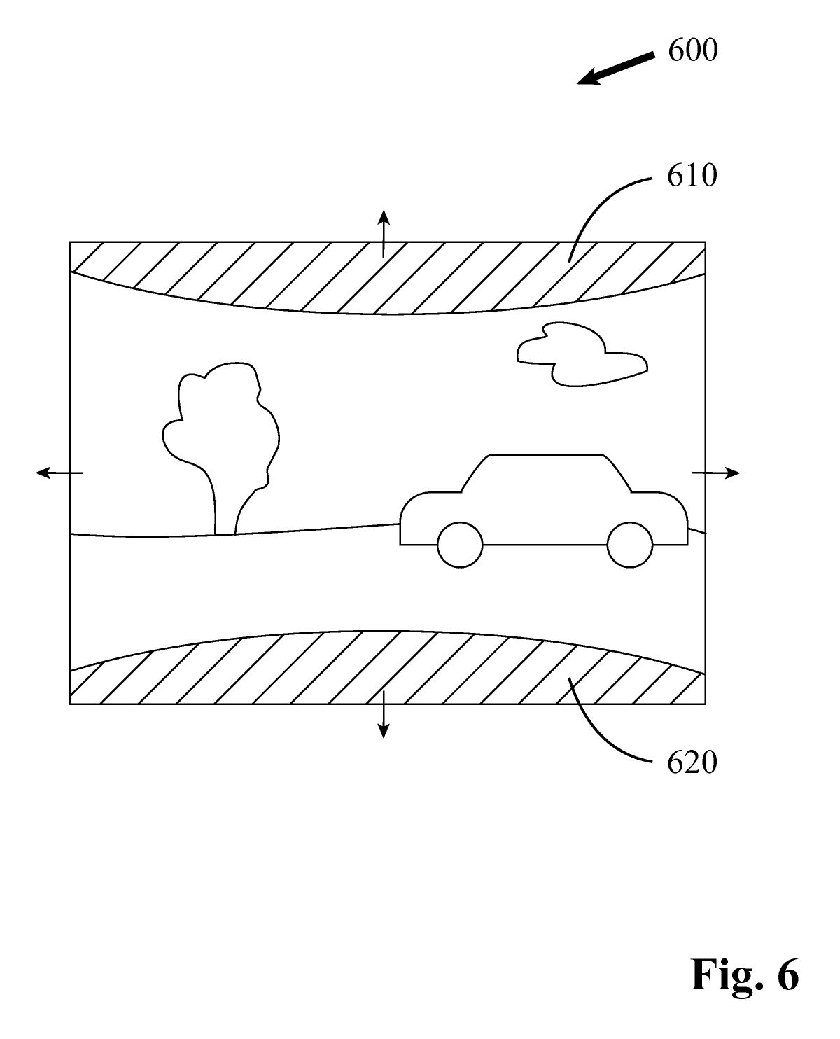

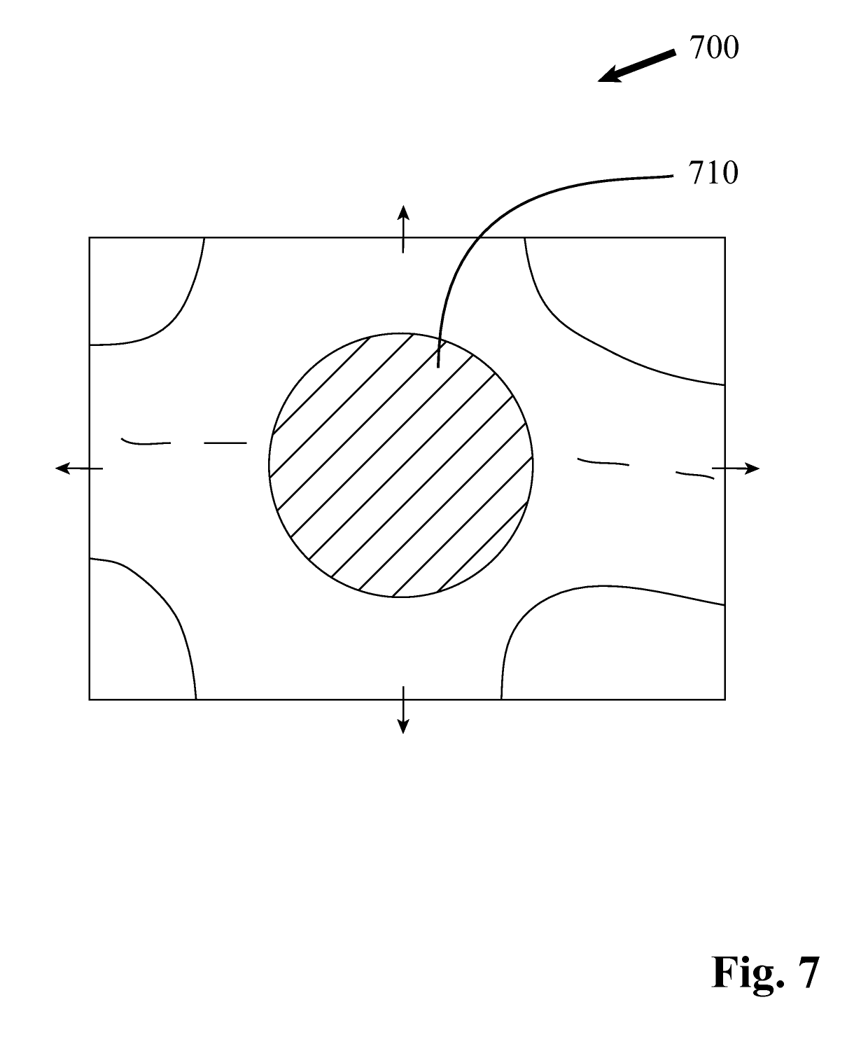

In some embodiments, as illustrated by the flow diagram of FIG. 5 and also by the exemplary VT views of FIGS. 6 and 7, ads may be presented in any available dead spaces, wherever there are dead spaces can be found in the virtual tours. These dead spaces may be the result of gaps in video coverage. Hence, it should also be appreciated that dead spaces may be found along the peripheral(s), along nadir(s), or in between otherwise adjacent video faces of panoramic video environments.

For example, the VT author and/or host may present lower peripheral ad(s) in a lower peripheral dead space 620 of a cylindrical panoramic video environment 600 for a virtual tour (step 520). Upper peripheral ad(s) may also be presented in an upper peripheral dead space 610 the cylindrical panoramic video environment 600 for the virtual tour (step 530).

Similarly, the VT author and/or host may present lower nadir ad(s) in a lower nadir 710 of a spherical panoramic video environment 700 for a virtual tour (step 580). As shown in step 590, upper nadir ad(s) may be presented in an upper nadir (not shown) of the spherical panoramic video environment 700 of the virtual tour.

In sum, the present invention provides systems and methods for renting modifiable ad locations of virtual tours for placement of annotated links to advertisements. The advantages of such systems and methods include increased potential revenue stream from ads, ability to modify ad locations to the needs of advertisers and ability to utilize dead spaces for the placement of ads.

While this invention has been described in terms of several embodiments, there are alterations, modifications, permutations, and substitute equivalents, which fall within the scope of this invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A computerized method for monetizing ad locations within a virtual tour configured for display on a mobile device, the method comprising:
generating a virtual tour configured for display on a mobile device;
reserving a modifiable ad location within the virtual tour;
assigning at least one annotated link to be located substantially within the modifiable ad location; and
monetizing the at least one annotated link by offering to associate the at least one annotated link to a renter.

2. A computerized method for monetizing ad locations within a virtual tour configured for display on a mobile device, the method comprising:
generating a virtual tour configured for display on a mobile device;
reserving a modifiable ad location within the virtual tour; and
monetizing the modifiable ad location by offering to associate the ad location with a renter.

3. The method of claim 1 wherein the ad location is designed by an author of the virtual tour.

4. The method of claim 1 wherein the ad location is configured to be modifiable by a renter of the at least one annotated link.

5. The method of claim 1 wherein the monetization of the at least one annotated link includes auctioning the at least one annotated link.

6. The method of claim 1 wherein the monetization of the at least one annotated link includes tracking a plurality of activations of the at least one annotated link.

7. The method of claim 2 further comprising modifying the ad location to include a direct ad.

8. The method of claim 2 further comprising assigning at least one annotated link to be located substantially within the ad location.

9. The method of claim 1 wherein the modifiable ad location is located in a dead space of the virtual tour.

10. The method of claim 9 wherein the dead space is a peripheral dead space.

11. The method of claim 9 wherein the dead space is a nadir dead space.

12. A computerized method for monetizing ad locations within a virtual tour configured for display on a mobile device, the method comprising:
retrieving a virtual tour configured for display on a mobile device;
identifying an existing annotated link in the virtual tour suitable for an advertisement; and
offering to rent the existing annotated link for the advertisement.

13. A computerized method for monetizing ad locations within a virtual tour configured for display on a mobile device, the method comprising:
retrieving a virtual tour configured for display on a mobile device;
identifying a potential modifiable ad location in the virtual tour suitable for locating an annotated link to an advertisement; and
offering to rent the modifiable ad location for the annotated link to the advertisement.

14. The method of claim 13 wherein the modifiable ad location is designed by an author of the virtual tour.

15. The method of claim 13 wherein the modifiable ad location is configured to be modifiable by a renter of the at least one annotated link.

16. The method of claim 13 wherein the modifiable ad location is located in a dead space of the virtual tour.

17. The method of claim 16 wherein the dead space is a peripheral dead space.

18. The method of claim 16 wherein the dead space is a nadir dead space.

19. A computerized method for monetizing ad locations within a virtual tour configured for display on a mobile device, the method comprising:
retrieving a virtual tour configured for display on a mobile device;
viewing at least one ad location of the virtual tour; and
activating an existing annotated link located substantially within the ad location to view an advertisement;

20. The method of claim 19 wherein the advertisement presented is a contextually relevant advertisement.

21. The method of claim 19 wherein the contextually relevant advertisement is based on at least one of a visitor profile and a visitor virtual tour route.

22. A virtual tour host server configured to monetize advertisement locations of virtual tours, the host server comprising:
memory configured to store a plurality of virtual tours;
an input-output port configured to communicate with a renter; and
a processor configured to:
generate a virtual tour configured for display on a mobile device;
reserve a modifiable advertisement location within the virtual tour;
assign at least one annotated link to be located substantially within the modifiable ad location; and
monetize the at least one annotated link by offering to associate the at least one annotated link to the renter.
